(19) United States
(12) Patent Application Publication
(10) Pub. No.: US 2019/0152439 A1
(43) Pub. Date: May 23, 2019

(54) AUTHENTICATION APPARATUS

(71) Applicant: JAGUAR LAND ROVER LIMITED, Coventry (GB)

(72) Inventor: LEWIS KELLY, Warwickshire (GB)

(21) Appl. No.: 16/195,348

(22) Filed: Nov. 19, 2018

(30) Foreign Application Priority Data
Nov. 20, 2017 (GB) 1719221.2

(51) Int. Cl. B60R 25/24; G06K 19/06; B60R 25/25

(52) U.S. Cl. CPC B60R 25/243; B60R 25/25; G06K 19/06037; G06K 19/06028

(57) ABSTRACT

An authentication apparatus for a vehicle can include: a camera; a processor; and a memory comprising stored authentication data. The authentication apparatus can be configured to: detect, by the camera, an identifying object associated with a user, the identifying object having a source of authentication data; read, by the processor, the source authentication data to provide read authentication data; compare, by the processor, the stored authentication data with the read authentication data; and, when the read authentication data matches the stored authentication data, selectively enable one or more functions of a vehicle to which the authentication apparatus is connectable, based on the read authentication data associated with the identifying object.

### CROSS REFERENCE TO RELATED APPLICATION

This application claims priority to and the benefit of Great Britain Patent Application No. 1719221.2 filed Nov. 20, 2017, which is incorporated by reference herein in its entirety.

### TECHNICAL FIELD

The present disclosure relates to an authentication apparatus. Particularly, but not exclusively, the disclosure relates to an authentication apparatus for a vehicle. Aspects of the invention relate to an authentication apparatus, to a vehicle, to a computer implemented method, to a computer program product, to a computer readable medium and to a controller.

### BACKGROUND

There is a desire to improve authentication provision for access to functions, for example, functions of vehicles, in order to ensure that only authorised users have access.

Keys are ordinarily provided in order to allow access to a vehicle. Keys can be passed to third parties, for example to provide access to a vehicle for maintenance, or to be driven. However, unless the original key is replicated, the original key needs to be passed to the third party.

The need to give the key to the third party may present difficulties, for example, in arranging a convenient and secure way of doing so. Further, in passing the key to the third party, the same level of access that the party passing the key has, is also passed to the third party.

It is known that a key can be replicated, and the replica key passed to the third party. However, replication of keys provides a risk, as the more keys there are, the more opportunities there are to lose the keys, or for the keys to be misused etc., and there is still a requirement to arrange a convenient and secure way of passing the replica key to a third party.

It is known to provide different keys to access different functions, however, this increases the number of keys that need to be dealt with and tracked and still requires arranging a convenient and secure way of passing keys to a third party to provide access to the functions.

It is an aim of the present invention to mitigate for at least some of the disadvantages associated with the prior art.

### SUMMARY

Aspects and embodiments of the invention provide an authentication apparatus, to a vehicle, to a computer implemented method, to a computer program product, to a computer readable medium and to a controller, as claimed in the appended claims.

According to an aspect of the invention, there is provided an authentication apparatus for a vehicle, the apparatus comprising: image detecting means; processing means; and memory means comprising stored authentication data; wherein: the authentication apparatus is configured to: detect, by the image detecting means, an identifying object associated with a user, the identifying object having a source of authentication data; read, by the processing means, the source authentication data thereby to provide read authentication data; compare, by the processing means, the stored authentication data with the read authentication data; and when the read authentication data matches the stored authentication data, the authentication apparatus is configured selectively to enable one or more functions of a vehicle to which the authentication apparatus is connectable, in dependence on the read authentication data associated with the identifying object.

Advantageously, objects that are widely or universally used to authenticate users can re-use the same data to authenticate a user, thereby to enable one or more functions on a vehicle. There is no need to exchange keys, or to provide different keys for different functions. One object, such as a driving licence, is used to provide access, which is centrally restricted and configurable for different situations. Beneficially, since identifying objects such as driving licences are already widely used and carried, there is no need to generate new objects, thereby providing an efficient way to enable access. Advantageously, the identifying object is associated with the person who is authorised to use functions, based on authentication, rather than being associated with the owner/main user of a vehicle. This means that there is no need to arrange for an exchange of a physical key.

Optionally, the authentication apparatus comprises receiving means, wherein the authentication apparatus is configured to receive information, by the receiving means, from a server to which the authentication apparatus is connectable, thereby to enable the memory means comprising stored authentication data to be updated.

Advantageously, the authentication apparatus receives data from a remote and secure source, such as a government database. Beneficially, the memory of the authentication apparatus is updated either by a user device, or by a server, providing the ability for the authentication apparatus to be configured as required and to operate in an offline situation. Advantageously, the use of receiving means enables the authentication apparatus to compare data received by the image detecting means with data held remotely.

Optionally, the authentication apparatus comprises transmitting means, wherein the authentication apparatus is configured to transmit information, by the transmitting means to an external device to which the authentication apparatus is connectable, thereby to provide information representing use of a vehicle to which the authentication apparatus is connectable.

Advantageously, the transmitting means transmits data to a remote and secure source, such as a government database, in order to compare data received by the image detecting means. Beneficially, updates regarding the operation of the controller are provided to a user and/or server, so that access to one or more functions of a vehicle can be tracked remotely. Advantageously, by transmitting such information, a remote user is able to confirm or amend authorisation based on authentication.

Optionally, the image detecting means comprises ultra violet (UV) light sensing means and/or an infra-red (IR) light sensing means.

Advantageously, different wavelengths of light are used to authenticate a user. When the light is UV or IR, a source of authentication data that is not visible to the human eye can be used, thereby increasing the difficulty with which an identifying object might be replicated.

Optionally, the authentication apparatus comprises a secondary authentication system, wherein the secondary authentication system is configured to correlate the identifying object to a user.

Advantageously, a secondary authentication system is used to verify that the user with the identifying object is the user associated with the identifying object.

Optionally, the secondary authentication system is configured to transmit, by transmitting means, information to a vehicle authority, the information indicative of the identity of the user, thereby to provide the vehicle authority with the means to authenticate and/or authorise use of a vehicle to which the authentication apparatus is connectable.

Beneficially, the secondary authentication system works with the authentication system to improve the security and accuracy with which a user is authenticated.

Optionally, the secondary authentication system is configured to receive, by receiving means, a signal to enable the one or more functions of a vehicle to which the vehicle authorisation system is connectable.

Advantageously, the secondary authentication system is triggered remotely, thereby enabling a remote user or system to confirm or deny authentication.

Optionally, the secondary authentication system is a biometric-based authentication system.

Beneficially, the biometric-based system is used to confirm that the holder of the identifying object is the user associated with the identifying object, thereby reducing the risk that an identifying object is used by a third party without authorisation.

Optionally, the identifying object is one of a driving licence, passport, ID card and government-issued identification.

Advantageously, using identifying objects such as driving licences, passports, ID cards and government-issued identification means that universal, established system are reused to provide authentication at a vehicle. Beneficially, this is an efficient system that avoids replication and can reuse establish methods of secure authentication. Advantageously, such identifying objects are widely used and therefore less new apparatus is required.

Optionally, the one or more functions are selected from a list of available functions in dependence on an access level associated with the user of the identifying object.

Advantageously, the apparatus is configurable to allow different levels of access to different users in different situations, for example limiting access to third party users based on configurable parameters.

Optionally, the source authentication data comprises at least one of a user image, company or issuing authority, ultra violet security mark, infra-red security mark, barcode, Quick Response (QR) code, special characters and text.

Optionally, the authentication apparatus is configured to read the source authentication data of the identifying object using optical character recognition and/or font pattern matching and or/visual recognition.

Beneficially, secure authentication data is used to enable a secure and convenient way of enabling one or more functions of a vehicle.

Optionally, the memory comprises stored authentication data forms part of a secure module of a vehicle to which the authentication apparatus is connectable.

Advantageously, the memory can be used as a secure module within a vehicle and updated to provide stored authentication data, as required.

Optionally, the authentication apparatus is configured selectively to enable the one or more functions of a vehicle to which the authentication apparatus is connectable for a predetermined time period.

Optionally, the predetermined time period has a start and/or an end time.

Optionally, the predetermined time period commences when the read authentication data matches the stored authentication data.

Advantageously, the vehicle functions are limited in their availability, in order to reduce extended and potentially undesirable use by third parties, or to prevent unauthorised parties using one or more vehicle functions without authentication.

Optionally, the authentication apparatus is configured selectively to enable the one or more functions of a vehicle to which the authentication apparatus is connectable in response to detecting the identifying object associated with a user for a predetermined number of uses, wherein, when the authentication apparatus detects the identifying object associated with a user more than the predetermined number of uses, the authentication apparatus prevents the one or more functions of a vehicle to which the authentication apparatus is connectable from being enabled.

Beneficially, the authentication apparatus is configured to prevent unlimited access to the one or more vehicle functions.

According to another aspect of the invention there is provided a vehicle comprising an authentication apparatus for a vehicle, the apparatus comprising: image detecting means; processing means; and memory means comprising stored authentication data; wherein: the authentication apparatus is configured to: detect, by the image detecting means, an identifying object associated with a user, the identifying object having a source of authentication data; read, by the processing means, the source authentication data thereby to provide read authentication data; compare, by the processing means, the stored authentication data with the read authentication data; and when the read authentication data matches the stored authentication data, the authentication apparatus is configured selectively to enable one or more functions of a vehicle to which the authentication apparatus is connectable, in dependence on the read authentication data associated with the identifying object.

According to a further aspect of the invention, there is provided a computer implemented method of authentication for a vehicle comprising: detecting an identifying object having a source of authentication data; reading the source of authentication data thereby to provide read authentication data; comparing the read authentication with stored authentication data; and when the read authentication data matches the stored authentication data: selectively enabling one or more functions of a vehicle, in dependence on the read authentication data associated with the identifying object.

According to yet a further aspect of the invention, there is provided a computer program product comprising instructions which, when the program is executed by a processor, cause the processor to carry out a method of authentication comprising: detecting an identifying object having a source of authentication data; reading the source of authentication data thereby to provide read authentication data; comparing the read authentication with stored authentication data; and when the read authentication data matches the stored authentication data: selectively enabling one or more functions of an authorised device such as a vehicle, in dependence on the read authentication data associated with the identifying object.

According to a yet further aspect of the invention, there is provided a computer readable medium having stored thereon a computer program product comprising instructions which, when the program is executed by a processor, cause the processor to carry out a method of authentication comprising: detecting an identifying object having a source of authentication data; reading the source of authentication data thereby to provide read authentication data; comparing the read authentication with stored authentication data; and when the read authentication data matches the stored authentication data: selectively enabling one or more functions of an authorised device such as a vehicle, in dependence on the read authentication data associated with the identifying object.

According to a yet further aspect of the invention, there is provided a controller configured to: detect an identifying object associated with a user, the identifying object having a source of authentication data; read the source authentication data thereby to provide read authentication data; compare stored authentication data with the read authentication data; and when the read authentication data matches the stored authentication data, the controller is configured selectively to output a signal to enable one or more functions of a vehicle to which the controller is connectable, in dependence on the read authentication data associated with the identifying object.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic of an authentication apparatus according to an embodiment of the invention;

FIG. 2 is a schematic of an authentication apparatus implemented in a vehicle, according to an embodiment of the invention; and

FIG. 3 is a flow chart of a method according to an embodiment of the invention.

### DETAILED DESCRIPTION OF THE EMBODIMENTS

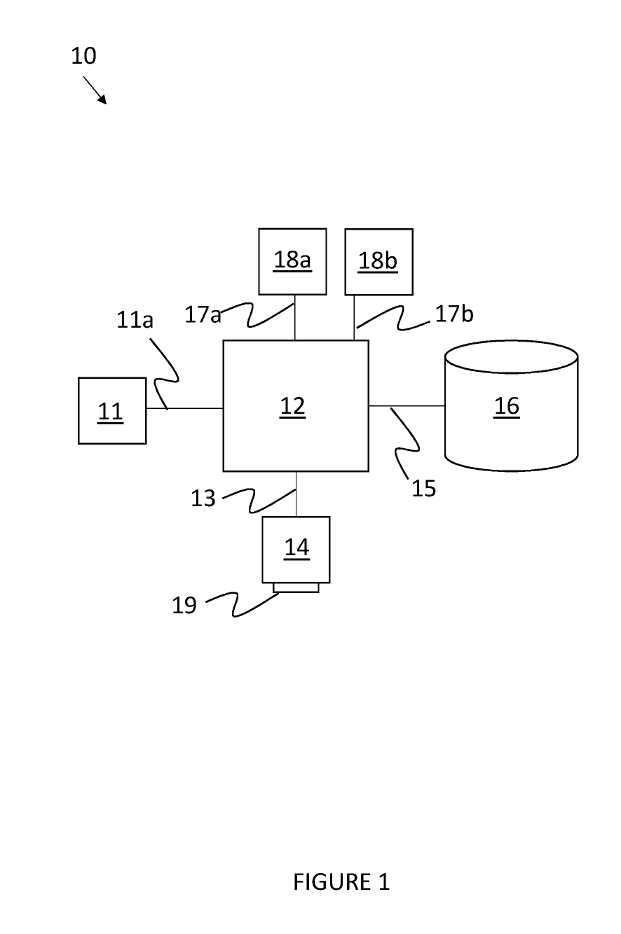

In order to provide access to one or more functions of a vehicle, an authentication apparatus is used to identify an object and provide access in dependence on the object identified. Advantageously, access is configurable and controlled, such that commonly used objects that are used as identifiers can be reused without the need to provide keys to third parties. Beneficially, the functions that are enabled by an identified object vary in any manner required, for example to allow access to a load-space/boot of a car, or to allow access to start a car, or to drive the car in a certain manner, or for a certain time, or distance, yet, no new key needs to be generated for each different scenario. Accordingly, the means and method for providing configurable, convenient and secure access to one or more vehicle functions are provided and described, with reference to FIGS. 1 to 3, below.

Whilst the authentication apparatus is described herein with reference to implementation in a car, the skilled person understands that the apparatus and principles described herein are applicable to any form of vehicle.

FIG. 1 is a schematic of an authentication apparatus 10 according to an embodiment of the invention. There is shown a controller 12 in communication with a memory 16 via a communication path 15. The controller 12 is also in communication with a receiver 18a via a communication path 17a. The controller 12 is also in communication with a transmitter 18b via a communication path 18b. The controller 12 is also in communication with a camera 14 via a communication path 13. The camera 14 has a sensing element 19. The controller 12 is configured to process data and is therefore also referred to as a processor 12. The controller 12 is also in communication with a vehicle function driver 11 via a communication path 11a. The controller 12 comprises a processor and/or a memory. In further embodiments, the controller 12 comprises any required component necessary to implement the functionality described herein.

The receiver 18a and the transmitter 18b are configured to receive and transmit wireless signals respectively. The receiver 18a and the transmitter 18b are configured to receive and transmit using any appropriate protocol and/or form of reception and transmission, e.g., Wi-Fi, cellular communication etc. In an embodiment the receiver 18a and the transmitter 18b are the same device (not shown), such as a transceiver device.

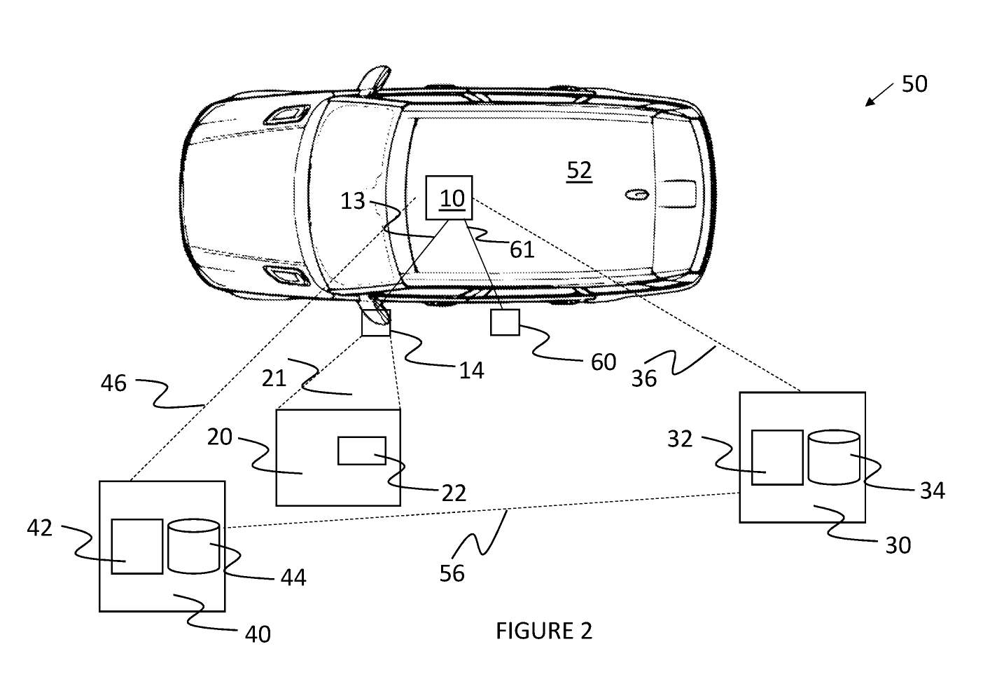

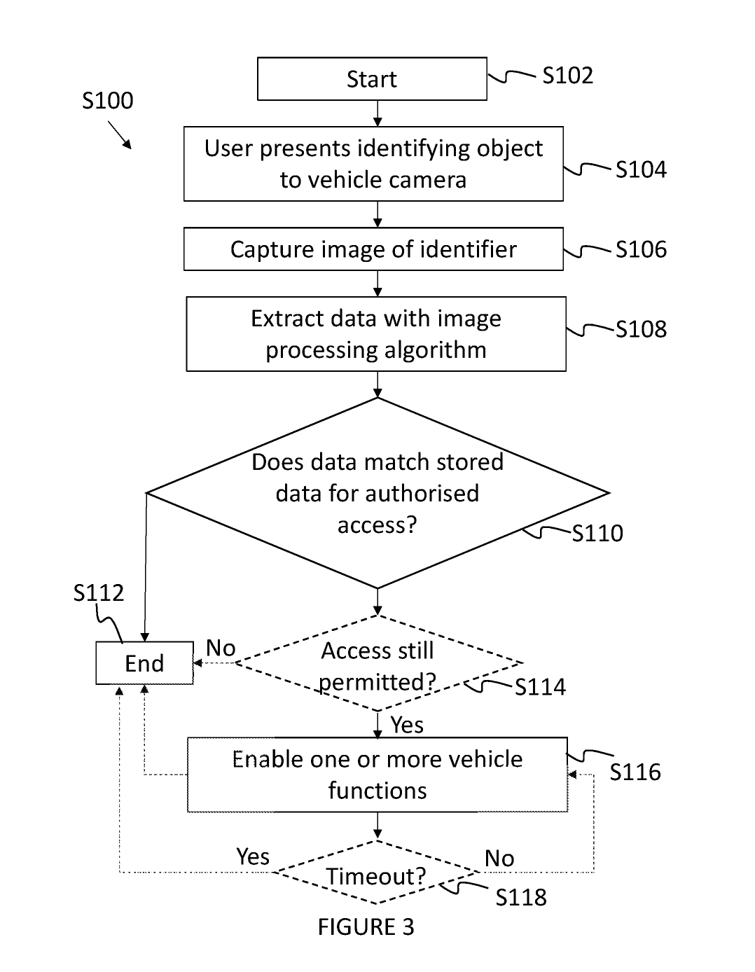

The vehicle function driver 11 is configured to connect one or more vehicle functions to the controller 12, thereby to enable the controller 12 to selectively implement one or more vehicle functions in dependence on successful authentication of a user. The vehicle function driver 11 is connectable to vehicle functions in a vehicle, such as vehicle 52, described below with reference to FIGS. 2 and 3. The vehicle functions may be vehicle start, access to the load-space/boot of a vehicle, access to drive the vehicle for a predetermined time/range, with a speed limit, within a pre-defined geo-fenced area of operation. The vehicle functions may be any vehicle functions that are configurable and for which authenticated access is desired.

Whilst the vehicle function driver 11 is shown to be connected to the controller 12 via communication path 11a, alternatively, or additionally, the controller 12 is in communication with the vehicle function driver 11 via any means that enables the controller 12 to implement one or more vehicle functions.

The camera 14 is an image detecting device. Alternatively, or additionally, the camera 14 is a video camera.

Whilst the camera 14 is shown without its own integrated processor and memory, alternatively, or additionally, the camera 14 has an integrated or separate processor and memory.

Whilst the camera 14 is shown to have a sensing element 19, alternatively or additionally, the camera 14 has any number of sensing elements, for example a sensing array. The sensing element 19 is used to detect visible light. Alternatively, or additionally, the sensing element 19 is used to detect any wavelength of light, such as ultraviolet (UV) or infrared (IR) light. Advantageously, different wavelengths of light are used to authenticate a user. When the light is UV or IR, a source of authentication data that is not visible to the human eye can be used, thereby increasing the difficulty with which an identifying object might be replicated.

The memory 16 that is in communication with the controller 12 via communication path 15 is an integrated part of the authentication apparatus 10, alternatively or additionally the memory 16 is an external memory of the authentication apparatus. Alternatively, or additionally, the memory is part of an external server. Alternatively, or additionally, the memory 16 is a separate entity from the authentication apparatus.

Whilst the receiver 18a and the transmitter 18b are shown as separate entities, alternatively, or additionally, the receiver 18a and the transmitter 18b are a single transceiver.

Advantageously, the authentication apparatus receives and transmits data from to and from a remote and secure source, such as a government database. Beneficially, the memory of the authentication apparatus is updated either by a user device, or by a server, providing the ability for the authentication apparatus to be configured as required and to operate in an offline situation. Advantageously, the use of receiving means enables the authentication apparatus to compare data received by the camera with data held remotely. Beneficially, updates regarding the operation of the controller 12 are provided to a user and/or server, so that access to one or more functions of a vehicle can be tracked remotely. Advantageously, by transmitting such information, a remote user is able to confirm or amend authorisation based on authentication.

The communication paths 13, 15, 17a, 17b and 61 described above in respect of FIGS. 1 and 2 are wired communication paths. Alternatively, or additionally, the communication paths 13, 15, 17a, 17b and 61 are wireless communication paths.

The authentication apparatus 10 described with respect to FIG. 1 can be implemented in a vehicle, such as the vehicle 52 described below, with reference to FIG. 2.

FIG. 2 is a schematic 50 of an authentication apparatus, such as the authentication apparatus 10 described in relation to FIG. 1, implemented in a vehicle 52, according to an embodiment of the invention. The authentication apparatus 10 is used to determine access to one or more functions of a vehicle 52 to which the authentication apparatus 10 is connectable. The authentication apparatus 10 interfaces with one or more vehicle functions through a vehicle function driver 11, described above in respect of FIG. 1.

Whilst there is shown the vehicle 52 with the authentication apparatus 10 situated in the vehicle 52, alternatively, or additionally, the authentication apparatus 10 is in communication with the vehicle 52 and includes one or more elements of the authentication apparatus 10 external to the vehicle 52.

There is shown an image detecting device such as a camera 14. The camera 14 forms part of the authentication apparatus 10. Alternatively, or additionally, the camera 14 is integrated with the authentication apparatus 10, or is external and distinct from the authentication apparatus 10. Alternatively, or additionally, the camera 14 is a camera that is used for one or more other pre-existing vehicle functions, such as a reversing camera. Alternatively, or additionally, there may be any number of cameras 14 in communication with the authentication apparatus 10.

The camera 14 is shown detecting an identification card 20 with a series of identifying marks acting as an identifier 22 in a detecting range 21 of the camera 14.

Whilst the detecting range 21 is shown with dotted lines in FIG. 2, the detecting range 21 is any range that is suitable for the necessary information to be retrieved in an image of an object, such as the identification card 20.

Whilst there is shown an identity card 20 with a series of identifying marks 22, alternatively, or additionally, the identity card 20 is any identifying object and the series of identifying marks acting as a source of authentication data 22 are any identifier or identifiers that enable the functionality described herein.

Advantageously, using identifying objects such as driving licences, passports, ID cards and government-issued identification means that universal, established systems are reused to provide authentication at a vehicle. Beneficially, this is an efficient system that avoids replication and can reuse establish methods of secure authentication. Advantageously, such identifying objects are widely used and therefore less new apparatus is required.

The source authentication data 22 comprises at least one of a user image, company or issuing authority, ultra violet security mark, infra-red security mark, barcode, Quick Response (QR) code, special characters and text. Optionally, the authentication apparatus is configured to read the source authentication data of the identifying object using optical character recognition and/or font pattern matching and or/visual recognition.

Beneficially, secure authentication data is used to enable a secure and convenient way of enabling one or more functions of a vehicle.

The authentication apparatus 10 is in communication with a server 30 via a communication path 36. The server 30 has a processor 32 and a memory 34. The authentication apparatus 10 is described in more detail with respect to FIGS. 1 and 3.

The authentication apparatus 10 is in communication with a user device 40 via a communication path 46. The user device has a processor 42 and a memory 44. The user device 40 is in communication with the server 30 via a communication path 56.

Whilst there is shown one server 30, alternatively, or additionally, there may be any number of servers. Alternatively, or additionally, other external devices are in communication with the authentication apparatus 10.

Whilst there is shown one server 30 and one user device 40, alternatively, or additionally, there may be any number of external devices. For example, there may be one user device 40, or one server 30, or one user device 40 and one server 30, or any combination of any number of user devices 40 and servers 30, which are external devices. The authentication apparatus 10, the server 30 and the user device 40 can form part of a telematics service for configurable access to one or more of the vehicle functions.

In FIG. 2, there is shown a secondary authentication device 60. The secondary authentication device 60 is in communication with the authentication apparatus 10 via a communication path 61. The secondary authentication device 60 is configured to provide a biometric measurement, such as a visual or audio measurement of a user, thereby to correlate the measurement with data stored in the memory 16 of the authentication apparatus 10.

Alternatively, or additionally, the secondary authentication device 60 is configured to provide a biometric measurement thereby to correlate the measurement with data stored in an external memory, such as the memory 44 of user device 40, or the memory 34 of the server 30. The secondary authentication device 60 is configured to provide information to the authentication apparatus 10 in order to determine the authentication of a user. Alternatively, or additionally, the secondary authentication device 60 is configure to locally determine authentication independently from the authentication device 10.

Whilst the secondary authentication device 60 is described as a device for authenticating using biometric measurements, alternatively, or additionally, the secondary authentication device 60 is configured to provide any suitable secondary authentication over and above the authentication provided by the authentication apparatus 10. The secondary authentication device 60 may have the same form as the authentication apparatus 10.

Whilst the secondary authentication device 60 is shown in communication with the authentication apparatus 10 via a communication path 61, alternatively, or additionally, the secondary authentication apparatus 60 is in communication with any combination of the authentication apparatus 10, the server 30 and the user device 40, thereby providing a secondary means for authenticating a user of an identifying object. Advantageously, a secondary authentication system is used to verify that the user with the identifying object is the user associated with the identifying object.

Beneficially, the biometric-based system is used to confirm that the holder of the identifying object is the user associated with the identifying object, thereby reducing the risk that an identifying object is used by a third party without authorisation.

Advantageously, the secondary authentication system can be triggered remotely, thereby enabling a remote user or system to confirm or deny authentication.

The communication paths 36, 46, 56, described in respect of FIG. 2 are wireless communication paths. Alternatively, or additionally, the communication paths 36, 46, 56 are at least in part wired communication paths.

The use of the authentication apparatus 10 described in respect of the implementation in a vehicle 52 at FIG. 2 is detailed below, with reference to FIG. 3.

Advantageously, objects that are widely or universally used to authenticate users can re-use the same data to authenticate a user, thereby to enable one or more functions on a vehicle. There is no need to exchange keys, or to provide different keys for different functions. One object, such as a driving licence, is used to provide access, which is centrally restricted and configurable for different situations. Beneficially, since identifying objects such as driving licences are already widely used and carried, there is no need to generate new objects, thereby providing an efficient way to enable access. Advantageously, the identifying object is associated with the person who is authorised to use functions, based on authentication, rather than being associated with the owner/main user of a vehicle. This means that there is no need to arrange for an exchange of a key.

FIG. 3 is a flow chart of a process S100 according to an embodiment of the invention. The process S100 is implemented at an authentication apparatus, such as the authentication apparatus 10 of FIG. 1. The process S100 can be implemented in a vehicle, such as vehicle 52 of FIG. 2.

The process S100 begins at step S102. The process S100 is implemented when a user presents an identity card 20 to a vehicle camera, as described at step S104. Alternatively, or additionally, the process S100 is implemented when a sensor (not shown) coupled with the authentication apparatus detects the presence of an object, or when a switch (not shown) coupled with the authentication apparatus is initiated. The switch may be part of a door handle, tailgate release or trunk release mechanism of the vehicle. The process may be initiated based on the current date/time matching that of a pre-arranged or scheduled event stored in a memory such as memory means 16.

The process then moves to step S104, where a user presents an identity card such as the identity card 20, described with respect to FIG. 3, which has a source of authentication data, such as identifier 22 to a vehicle camera, such as the camera 14 described with respect to FIGS. 1 and 3.

The process then moves to step S106, where the camera 14 captures an image of the identifier 22 of the identity card 20. The image of the identity card 20 is processed at a controller, such as the controller 12 of the authentication apparatus 10. The controller 12 determines what type of identity card the identity card 12. Advantageously, standard identity cards can be used, thereby providing a known and universal format of data that can be used to authenticate a user.

The process moves to step S108, where the controller 12 extracts information from the identifier 22 of the identity card 20 using an image processing algorithm. The information that is extracted is dependent on the type of identity card that is used. For example, the identity card may include a user's image, company or issuing authority logo, ultraviolet or infrared security marks, written information such as names, numbers, special characters, barcodes, QR codes etc. The controller 12 reads the data of the identifier 22 thereby to provide read source authentication data that is usable in a comparison with stored authentication data.

The process then moves to step S110. At step S110, the controller 12 determines whether the information extracted at step S110 matches stored information corresponding to authentication data stored in the memory 16. The authentication data stored in the memory 16 is correlated to authorisation to implement one or more functions of a vehicle.

Whilst the controller 12 determines whether the information extracted at step S110 matches stored information corresponding to authorised access stored in the memory 16, alternatively, or additionally, the controller 12 determines whether the information extracted at step S110 matches information corresponding to authorised access stored in a different memory, such as the memory 34 of a server 30, or the memory 44 of a user device 40.

When the extracted read source of authentication data does not match authentication data stored in the memory 16 corresponding to authorised access, the process moves to step S112, where the process S100 ends. When the extracted read source of authentication data does match authentication data stored in the memory 16, the process optionally moves to step S114, where it is determined by the controller 12 if access is still permitted.

If it is determined by the controller 12 if access is still permitted and the controller 12 determines that access is no longer permitted, the process moves to step S112, where the process S100 ends. The controller 12 determines if access is still permitted in dependence on a duration of time that has passed since an identifying object was used to authenticate a user with the permitted time for which a user is authenticated, where the permitted time for which the user is authenticated is stored in the memory 16. Alternatively, or additionally, the permitted time for which the user is authenticated is stored in the memory 44 of the server 40 or the memory 34 of the user device 30.

If it is determined by the controller 12 if access is still permitted and the controller 12 determines that access is permitted, the process S100 moves to step S116, where one or more vehicle functions are enabled or continue to be enabled. The one or more vehicle functions are enabled by the controller 12 outputting a signal via communication path 11a to the vehicle function driver 11, which is in communication with the one or more vehicle functions that are enabled at step S116.

Alternatively, or additionally, different mechanisms are used to determine whether access is still permitted. These include, but are not limited to: a predetermined start and/or finish time, a predetermined duration initiated at a predetermined time, a pre-determined scheduled event, such as a calendar entry held in a memory and associated with the owner or main user of the vehicle, or in response to a predetermined event.

Alternatively, the process S100 moves from step S110 directly to step S114 without determining whether access is still permitted. The process then ends at step S112.

Advantageously, the vehicle functions are limited in their availability, in order to reduce extended and potentially undesirable use by third parties, or to prevent unauthorised parties using one or more vehicle functions without authentication.

The process S100 may be implemented as often as required and may be performed in response to the detection of any type of identifying object.

Optionally, the process moves from step S116 to step S118, where it is determined by the controller 12 if the authentication and subsequent authorisation has timed out. If the controller determines whether the process has timed out and the controller 12 determines that the process has not timed out, then the process moves to step S116, where the one or more vehicle functions are enabled.

If the controller 12 determines whether the process has timed out and determines that the process has timed out, the process moves to step S112, where the process ends and the one or more vehicle functions are no longer enabled.

The one or more functions enabled at step S116 includes engine start, access through one or more entry points of a vehicle, such as into the load-space of a vehicle, limited use of a vehicle in respect of the speed or distance it is used for, a pre-defined geographical area or region, different speed restrictions for different users.

Whilst at step S110 the authentication apparatus 10 is described as performing a comparison of the read source authentication data from step S108 with stored authentication data in the memory 16, alternatively or additionally, the authentication apparatus 10 is configured to communicate with the server 30 via the communication path 36, thereby to verify authentication details at step S110. Alternatively, or additionally, if the authentication apparatus 10 is unable to communicate with the server 30 thereby to verify the authentication details at step S110, the authentication apparatus 10 is configured to determine a match at step S110 by comparison of the data extracted at step S108 with locally stored data in the memory 16. The authentication apparatus 10 is configured to update the memory 16 at convenient times, so as to ensure that authentication can take place in offline situations, for example where wireless communication between the authentication apparatus 10 and the server 30 is not possible.

Advantageously, the authentication apparatus receives data from a remote and secure source, such as a government database. Beneficially, the memory of the authentication apparatus is updated either by a user device, or by a server, providing the ability for the authentication apparatus to be configured as required and to operate in an offline situation. Advantageously, the use of receiving means enables the authentication apparatus to compare data received by the image detecting means with data held remotely.

The authentication apparatus 10 is optionally configured to transmit data to the user device 30 via the transmitter 18b in response to performing any of the steps detailed with respect to the process flow S100. The data sent from the authentication apparatus 10 to the user device 40 is used to update a user of the user device 40, such as an owner of the vehicle 52, when authentication has been attempted/succeeded/failed at the authentication apparatus 10. A user of the user device 40 may update authorisation details at either or both of the authentication apparatus 10 memory 16 and the server 30 memory 34 via any of the communication paths 36, 46 and 56.

1. An authentication apparatus for a vehicle, the apparatus comprising:
a camera configured to detect an identifying object associated with a user, the identifying object having a source of authentication data;
a memory comprising stored authentication data; and
a controller configured to:
read the source of authentication data to provide read authentication data;
compare the stored authentication data with the read authentication data; and
responsive to the read authentication data matching the stored authentication data, selectively enable one or more functions of a vehicle to which the authentication apparatus is connectable, based on the read authentication data associated with the identifying object.

2. The authentication apparatus of claim 1, further comprising a receiver configured to receive information from a server to which the authentication apparatus is connectable, to enable the memory comprising stored authentication data to be updated.

3. The authentication apparatus of claim 1, further comprising a transmitter configured to transmit information to an external device to which the authentication apparatus is connectable, to provide information representing use of a vehicle to which the authentication apparatus is connectable.

4. The authentication apparatus of claim 1, wherein the camera comprises either or both of an ultra violet light sensor and an infra-red light sensor.

5. The authentication apparatus of claim 1, further comprising a secondary authentication system configured to correlate the identifying object to a user.

6. The authentication apparatus of claim 5, wherein the secondary authentication system is further configured to transmit, by a transmitter, information to a vehicle authority, the information indicative of the identity of the user, to provide the vehicle authority with the means to authenticate and/or authorise use of a vehicle to which the authentication apparatus is connectable.

7. The authentication apparatus of claim 5, wherein the secondary authentication system is further configured to receive, by the receiver, a signal to enable the one or more functions of a vehicle to which the authentication apparatus is connectable.

8. The authentication apparatus of claim 5, wherein the secondary authentication system includes a biometric-based authentication system.

9. The authentication apparatus of claim 1, wherein the identifying object is one of the following: a driving licence, a passport, an ID card, and a government-issued identification.

10. The authentication apparatus of claim 1, wherein the one or more functions are selected from a list of available functions based on an access level associated with the user of the identifying object.

11. The authentication apparatus of claim 1, wherein the source authentication data comprises at least one of the following: a user image, a company or issuing authority, an ultra violet security mark, an infra-red security mark, a barcode, a Quick Response (QR) code, one or more special characters, and text.

12. The authentication apparatus of claim 1, wherein the memory comprising stored authentication data forms part of a secure module of a vehicle to which the authentication apparatus is connectable.

13. The authentication apparatus of claim 1, wherein the authentication apparatus is configured to selectively enable the one or more functions of a vehicle to which the authentication apparatus is connectable for a predetermined time period, the predetermined time period having either or both of a start and an end time.

14. The authentication apparatus of claim 13, wherein the predetermined time period commences when the read authentication data matches the stored authentication data.

15. The authentication apparatus of claim 1, wherein the authentication apparatus is configured to selectively enable the one or more functions of a vehicle to which the authentication apparatus is connectable in response to detecting the identifying object associated with a user for a predetermined number of uses, wherein, when the authentication apparatus detects the identifying object associated with a user more than the predetermined number of uses, the authentication apparatus prevents the one or more functions of a vehicle to which the authentication apparatus is connectable from being enabled.

16. A vehicle comprising the authentication apparatus of claim 1.

17. A computer implemented method of authentication for a vehicle, the method comprising:
detecting an identifying object having a source of authentication data;
reading the source authentication data to provide read authentication data;
comparing the read authentication with stored authentication data; and
responsive to the read authentication data matching the stored authentication data, selectively enabling one or more functions of a vehicle, based on the read authentication data associated with the identifying object.

18. A computer program product comprising instructions which, when executed by a processor, cause the processor to perform the method of claim 17.

19. A computer readable medium having stored thereon the computer program product of claim 18.

20. A controller for a vehicle configured to:
detect an identifying object associated with a user, the identifying object having a source of authentication data;
read the source authentication data to provide read authentication data;
compare stored authentication data with the read authentication data; and
responsive to the read authentication data matching the stored authentication data, selectively output a signal to enable one or more functions of a vehicle to which the controller is connectable, based on the read authentication data associated with the identifying object.
